(19) United States
(12) Patent Application Publication
(10) Pub. No.: US 2017/0282941 A1
(43) Pub. Date: Oct. 5, 2017

(54) RAIL CAR LIFTING DEVICE

(71) Applicant: Mi-Jack Products, Inc., Hazel Crest, IL (US)

(72) Inventors: John J. Lanigan, SR., Orland Park, IL (US); Martin C. Conneally, Downers Grove, IL (US); Antonio Carlos Callado Souza, Chicago, IL (US); Jason Schmidt, Flossmoor, IL (US)

(21) Appl. No.: 15/087,325

(22) Filed: Mar. 31, 2016

(51) Int. Cl. B61K 5/00; B66F 3/28

(52) U.S. Cl. CPC B61K 5/00; B66F 3/28

(57) ABSTRACT

A lifting device for lifting a rail car includes a frame with a load plate movably disposed thereon and a back plate movably disposed on the frame and coupled to the load plate. The lifting device further includes a first actuator disposed on the frame and operatively coupled to the back plate and at least one second actuator operatively coupled to the load plate such that the first actuator and the at least one second actuator produce forces in first and second directions. Further still, the first actuator and the at least one second actuator move the load plate of the lifting device in a substantially vertical direction.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### FIELD OF THE DISCLOSURE

The present subject matter relates to lifting devices, and more particularly, to a lifting device used to raise a rail car.

### BACKGROUND

The vast majority of freight in the United States travels by rail car. Increasingly, more and more of the freight shipped by rail cars travels in intermodal containers. These intermodal containers are carried on rail cars that roll on wheel and axle assemblies. As with automobile tires, the wheel and axle assemblies on rail cars must be periodically replaced due to wear or damage incurred while in transit.

Unlike the changing of an automobile tire, the changing of a rail car wheel and axle assembly may be a difficult and time-consuming process that may require the use of several pieces of machinery. Given the size and weight of the equipment involved, it may also present dangers to personnel and equipment performing the maintenance.

Conventional wheel changing is accomplished using wheel trucks that employ jacks and a crane to lift the rail car. The process may also be performed using sidewinder vehicles that are similar to a front-end loader with a boom on one side and a counterweight on the side opposite the boom. Such an operation requires one sidewinder to be positioned on each side of the rail car so that the respective boom of each vehicle may be hooked to the rail car through the use of chains placed on the car. The booms then lift and suspend the car while work crews roll the old wheel out from under the rail car and replace it by rolling a new wheel into position. This evolution requires several heavy pieces of equipment and numerous support personnel to carry out the task of changing the wheel.

A device that would allow for the lifting of a rail car and facilitate the changing of a wheel and axle assembly using a limited number of people and pieces of equipment would be an improvement in the art.

### SUMMARY

According to one aspect, a lifting device for lifting a rail car includes a frame with a load plate movably disposed thereon and a back plate movably disposed on the frame and coupled to the load plate. The lifting device further includes a first actuator disposed on the frame and operatively coupled to the back plate and at least one second actuator operatively coupled to the load plate such that the first actuator and the at least one second actuator produce forces in first and second directions. Further still, the first actuator and the at least one second actuator move the load plate of the lifting device in a substantially vertical direction.

According to another aspect, a method of lifting a rail car includes arranging a lifting device across a rail way such that a rail car is above the lifting device. The lifting device used in the method includes a frame with a load plate movably disposed thereon and a back plate is movably disposed on the frame and coupled to the load plate. The method further includes raising the rail car through moving the load plate vertically by activating a first actuator disposed on the frame and operatively coupled to the back plate such that the first actuator produces a force in a first direction, and activating at least one second actuator operatively coupled to the load plate such that the at least one second actuator produces a force in a second direction transverse to the first direction. Further still in the method, the first actuator and the at least one second actuator operate together to move the load plate vertically.

Other aspects and advantages of the present invention will become apparent upon consideration of the following detailed description and the attached drawings wherein like numerals designate like structures throughout the specification.

### BRIEF DESCRIPTION OF THE DRAWINGS

FIG. 1 is an isometric front view of a lifting device in a retracted position;

FIG. 2 is an isometric back view of the lifting device in the retracted position;

FIG. 3 is an isometric front view of the lifting device in the retracted position arranged underneath a rail car;

FIG. 4 is an isometric front view of the lifting device in a partially deployed position;

FIG. 5 is an isometric back view of the lifting device in the partially deployed position;

FIG. 6 is an isometric front view of the lifting device in a deployed position;

FIG. 7 is an isometric back view of the lifting device in the deployed position;

FIG. 8 is an isometric front view of the lifting device in the deployed position arranged such that the rail car is lifted;

FIG. 9 is an isometric back view of the lifting device in the deployed position arranged such that the rail car is lifted;

FIG. 10 is an isometric view of the back of the lifting device showing a back plate and frame of the lifting device when said back plate is partially supported by pins extending from the frame;

FIG. 11 is an isometric view of the back of the lifting device showing the back plate and frame with the pins disengaged;

FIG. 12 is an exploded view of the lifting device;

FIG. 13 is a side elevational view of the lifting device arranged on a railway;

FIG. 14 is a front isometric view from above of the lifting device arranged on the railway;

FIG. 15 is a detailed front isometric view from above of the lifting device with a portion of the load plate cut away;

FIG. 16 is a detailed front isometric view from above of the lifting device with portions of the load plate and frame cut away; and

FIG. 17 is a detailed front isometric view from above of the lifting device with increased portions of the load plate and the frame cut away.

### DETAILED DESCRIPTION

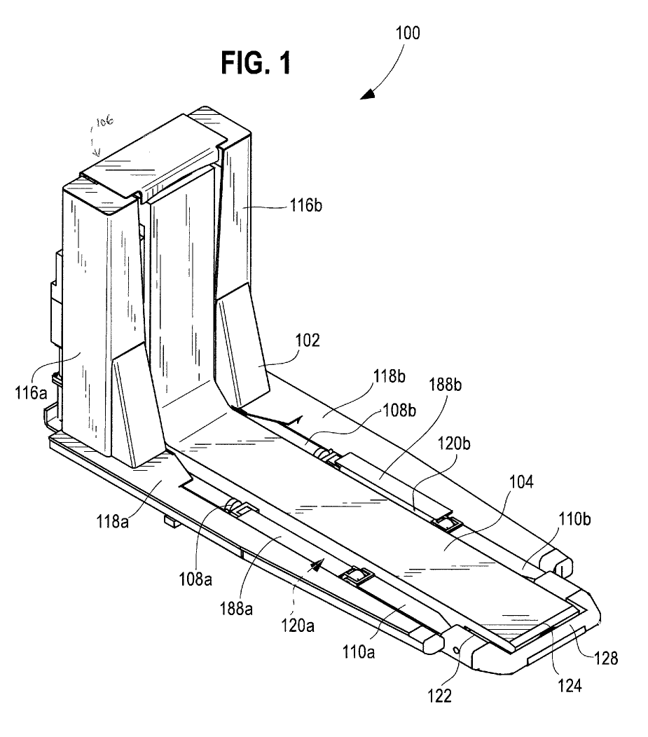

As shown in FIGS. 1, 2, 4, 5, 6, 7, 10, 11, and 12 disclosed is a lifting device 100 for lifting or partially lifting rail cars. Referring now to FIG. 1, the lifting device includes a frame 102, a load plate 104 movably disposed on the frame 102, and a back plate 106 moveably disposed on the frame 102. The lifting device further includes first and second horizontal actuators 108a, 108b as well as first and second arm members 110a, 110b.

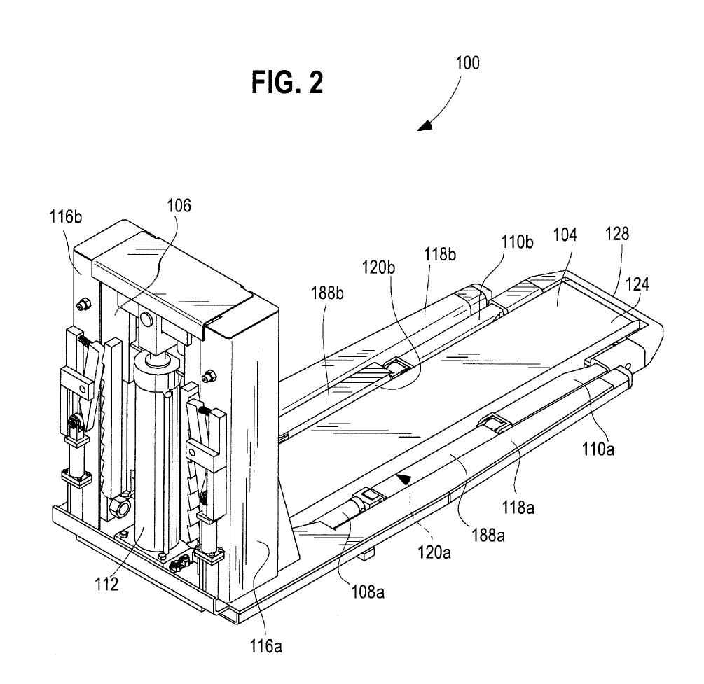

Referring now to FIG. 2, the lifting device 100 is depicted such that a backside of the frame 102 is shown. The lifting device 100 further includes a first vertical actuator 112 disposed on the frame 102 and operatively coupled to the back plate 106. The vertical actuator 112 transmits to the back plate 106 a first force in a generally upward, first direction. In the depicted embodiment, the first vertical actuator 112 has a bottom end coupled to the frame 102 and an upper end pinned proximal to a top edge of the back plate 106. The bottom end of the first vertical actuator 112 may be bolted down or secured to the frame in another suitable fashion. The end of the first vertical actuator 112 pinned to the top of the back plate 106 may be coupled thereto by a hinge or another suitable connection allowing side-to-side motion of the back plate 106. Additionally, the first and second horizontal actuators 108a, 108b are operatively coupled to a distal end 126 of the load plate 104 through the first and second aRM members 110a, 110b. The actuators 108a, 108b, 112 may be hydraulic cylinders, pneumatic cylinders, electric linear actuators, or any other suitable type of actuator.

The first and second horizontal actuators 108a, 108b transmit a generally horizontal force to the first and second arm members 110a, 110b in a second direction substantially transverse to the first direction. In example embodiments, each arm member 110a, 110b may be a slide crank. Further, the first and second horizontal actuators 108a, 108b may be attached to the frame 102 using a clevis pin or any other suitable connection type. Thereby, the first and second arm members 110a, 110b transfer the force produced by the first and second horizontal actuators 108a, 108b to the load plate 104, causing the load plate 104 to rise in a substantially vertical direction.

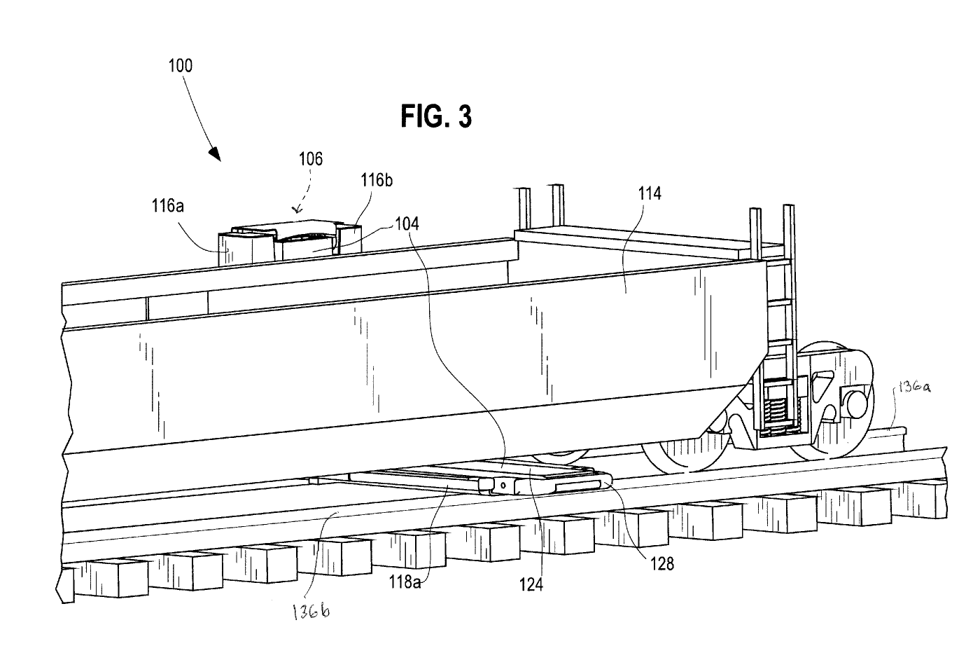

The vertical forces received at the load plate 104 from the first and second arm members 110a, 110b and the first vertical actuator 112 provide the force necessary for the load plate 104 to vertically lift a load, such as a rail car 114 positioned over the load plate 104 as seen in FIG. 3. The load plate 104, arm members 110a, 110b, and actuators 112, 108a, 108b begin in a first, retracted position shown in FIGS. 1-3. Likewise, the rail car 114 begins in a first, bottom position arranged above the load plate 104 but not necessarily making contact with the load plate 104 or the back plate 106, although the rail car may rest against the load plate 104 and/or back plate 106 when in the bottom position.

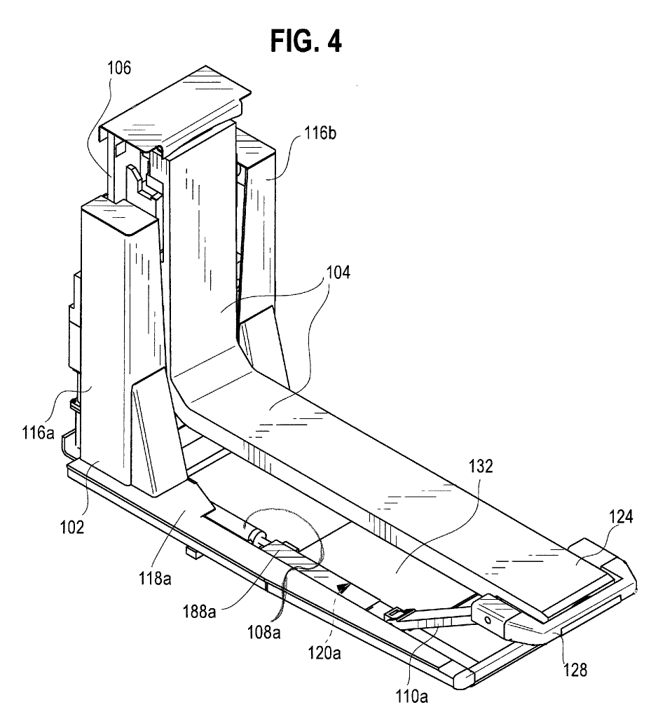

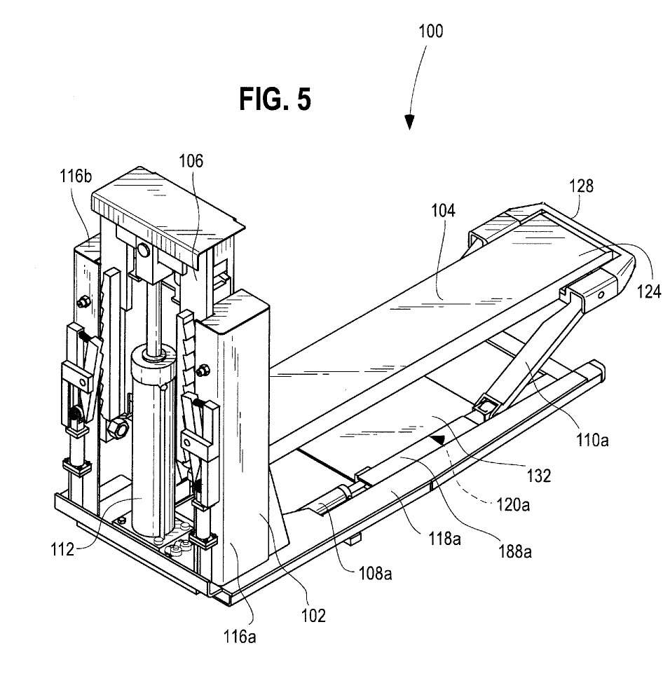

From the first, retracted position the load plate 104 lifts vertically, as shown in FIGS. 4 and 5. The back plate 106 rises vertically in response to the first vertical actuator 112. As the back plate 106 rises, it separates from the first and second vertical side members 116a, 116b of the frame 102. Additionally, the load plate 104 rises vertically in response to the hinging movement of the first and second arm members 110a, 110b. The hinging movement of the first and second arm members 110a, 110b is effectuated by the first and second horizontal actuators 108a, 108b. The first and second horizontal actuators are arranged alongside and anchored by respective first and second horizontal leg members of the frame 118a, 118b. Alternatively, the first and second horizontal actuators 108a, 108b may instead be anchored to the first and second side member 116a, 116b and merely be configured to run alongside the first and second horizontal leg members 118a, 118b of the frame 102.

In alternative embodiments, there may instead be one horizontal actuator, one leg member, and one arm member. In other alternative embodiments, there may be more than two horizontal actuators, more than two leg members, and more than two arm members. Further alternative embodiments may combine the first and second side members 116a, 116b into a single upright frame member. Such alternative embodiments may be combined as may be suitable for a particular application.

The first and second horizontal leg members 118a, 118b are disposed substantially parallel to and spaced apart from one another. Further, each horizontal leg member 118a, 118b includes a slide member 120a, 120b that transfers the force of each horizontal actuator 108a, 108b to the respective arm member 110a, 110b. In an example embodiment, the load plate 104 is disposed between the first and second horizontal leg members 118a, 118b and the slide members 120a, 120b move horizontally, transverse to the vertical rise of the load plate 104, to cause the hinging motion of the first and second horizontal arm members 110a, 110b. In example embodiments, the slide members 120a, 120b may be replaced by or combined with a platen 132 arranged between the first and second horizontal leg members 118a, 118b of the frame 102. In alternative example embodiments, the horizontal motion of the slide members 120a, 120b and first and second horizontal actuators 108a, 108b may be used to drive a scissor mechanism or some other type of linkage arrangement. Further, the connections between the first and second arm members 110a, 110b and the first and second slide members 120a, 120b direct the vertical load from the distal end 124 of the load plate 104 to the respective horizontal leg members 118a, 118b of the frame 102 on either side of the lifting device 100.

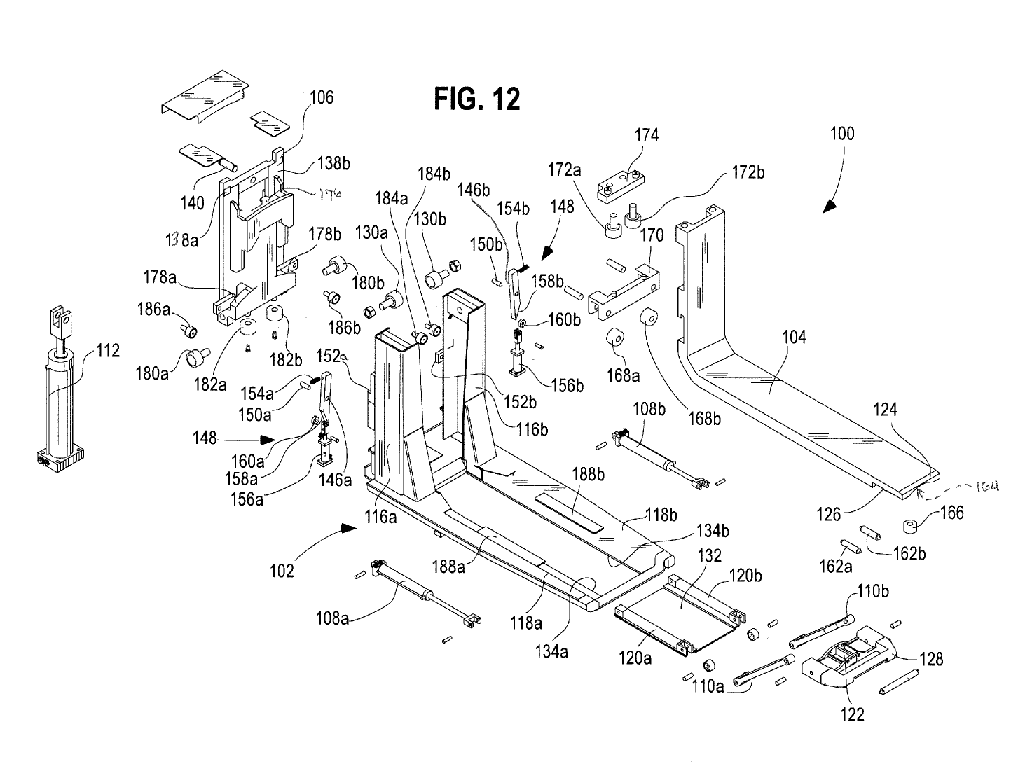

The horizontal leg members 118a, 118b of the frame 102 guide the platen 132 and the slide members 120a, 120b. Slide members 120a, 120b may cam along the sides of horizontal leg members 118a, 118b. The platen 132 is formed to fit between 118a and 118b. When the load plate 104 is in the first, retracted position the platen 132 is underneath the load plate 104. The slide members 120a, 120b, and the platen 132 connecting such slide members 120a, 120b, may be guided by the lowest inside vertical surface 134a, 134b (see FIG. 12) on the inside of horizontal leg members 118a, 118b. Wear pads may be arranged between the horizontal leg members 118a, 118b and the slide members 120a, 120b. In example embodiments, the wear pads may be fixed to outside vertical surfaces of the slide members 120a, 120b to prevent deterioration as the slide members 120a, 120b slide along the lowest inside vertical surfaces 134a, 134b of the horizontal leg members 118a, 118b.

The platen 132 coupling first and second slide members 120a, 120b may operate to keep the horizontal actuators 108a, 108b synchronized to prevent the first and second arm members 110a, 110b from raising the respective sides of the load plate 104 uneven vertical distances. Housing plates 188a, 188b may cover portions of the horizontal leg members 118a, 118b, the slide members 120a, 120b, and the horizontal actuators 108a, 108b. These housing plates 188a, 188b may be welded to the horizontal leg members 118a, 118b above the space occupied by slide members 120a, 120b. The pinned couplings between the first and second horizontal actuators 108a, 108b, the first and second slide members 120a, 120b, and the first and second arm members 110a, 110b are held in alignment by these housing plates 188a, 188b such that buckling of the pinned couplings is prevented.

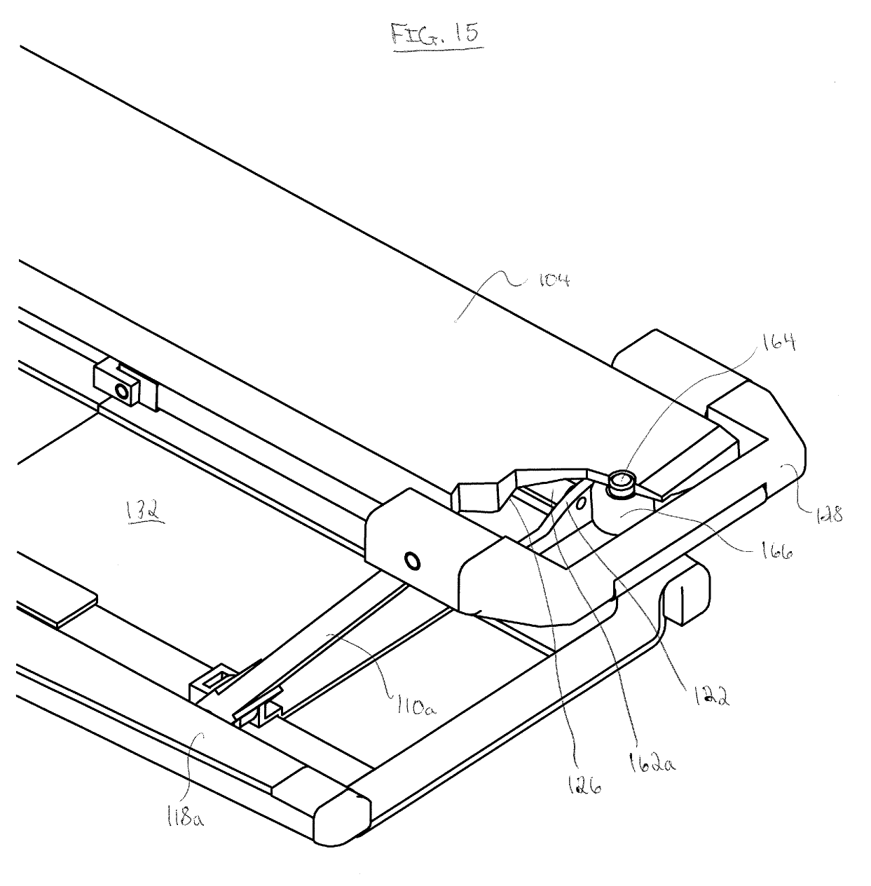

As seen in FIGS. 1, 2, 4, and 5, the first and second arm members 110a, 110b are operatively coupled to an end of the load plate 104 distal to the first and second side members 116a, 116b of the frame 102. The first and second arm members 110a, 110b may be connected to the load plate by hinges, trunnions, ball joints, or another suitable connection type. The load plate 104 has an end surface 124 distal to the back plate 106 that defines a channel 126, as seen in FIG. 12, extending along a horizontal axis of the load plate 104. At least one trunnion 122 is positioned within the channel (see FIG. 15). Further, a protective cap 128 partially surrounds the end surface 124 of the load plate 104.

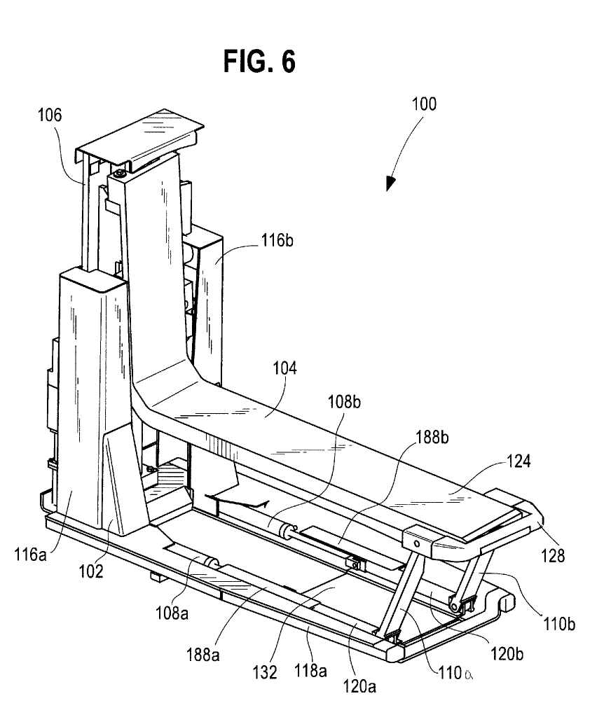

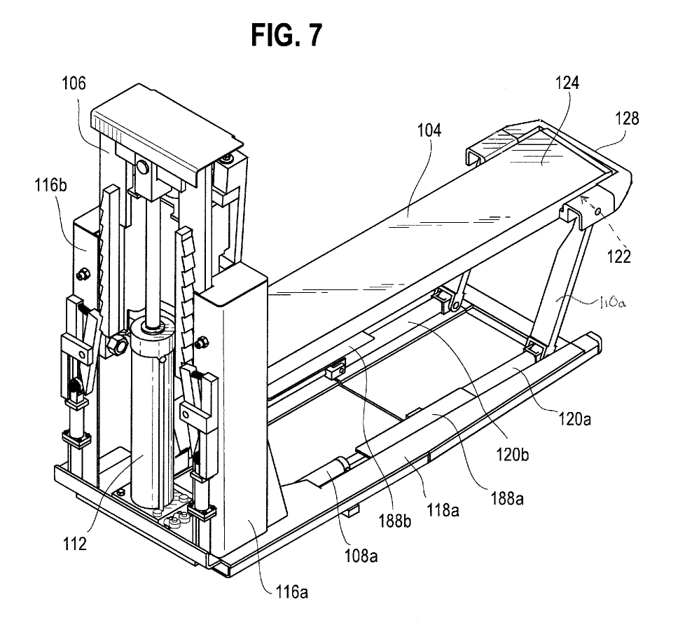

Referring now to FIGS. 6 and 7, the load plate 104 and back plate 106 are shown reaching the second, extended position. In the second, extended position, the back plate 104 has risen further above the first and second side members 116a, 116b. Additionally, the first and second slide members 120a, 120b have moved further horizontally as a result of continued force exerted by the first and second horizontal actuators 108a, 108b. The movement of the first and second slide members 120a, 120b causes corresponding additional hinging movement of the first and second arm members 110a, 110b effectuating further rise of the load plate 104.

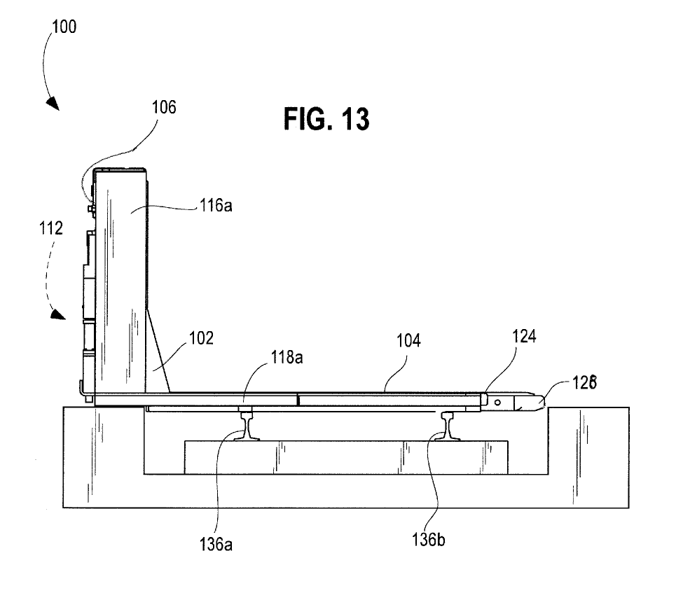

In the example embodiment shown in FIGS. 6 and 7, the load plate 104 reaches the second, extended position before the arm members 110a, 110b have fully hinged to a vertical position forming right angles with the respective first and second horizontal leg members 118a, 118b of the frame 102. In the example embodiment shown, the angle of the arm members 110a, 110b when the load plate 104 reaches the second, extended position is optimized to transfer the load from the load plate 104 through the frame 102 to the top of the rail 136b supporting the distal end 124 of the load plate 104 and lifting device 100 (see FIG. 13 showing rails 136a, 136b). In alternative embodiments, the second, extended position of the load plate 104 may correspond to an arm member position that is at 90 degrees to the horizontal leg members 118a, 118b or past 90 degrees such that the angle formed interior to the lifting device 100 between each arm member 110a, 110b with the respective horizontal leg member 118a, 118b is acute. Further still, the upper, extended position of the load plate 104 may be within a vertical range from the leg members 118a, 118b of the frame 102, and/or within a range of angles between the arm members 110a, 110b and the leg members 118a, 118b of the frame 102.

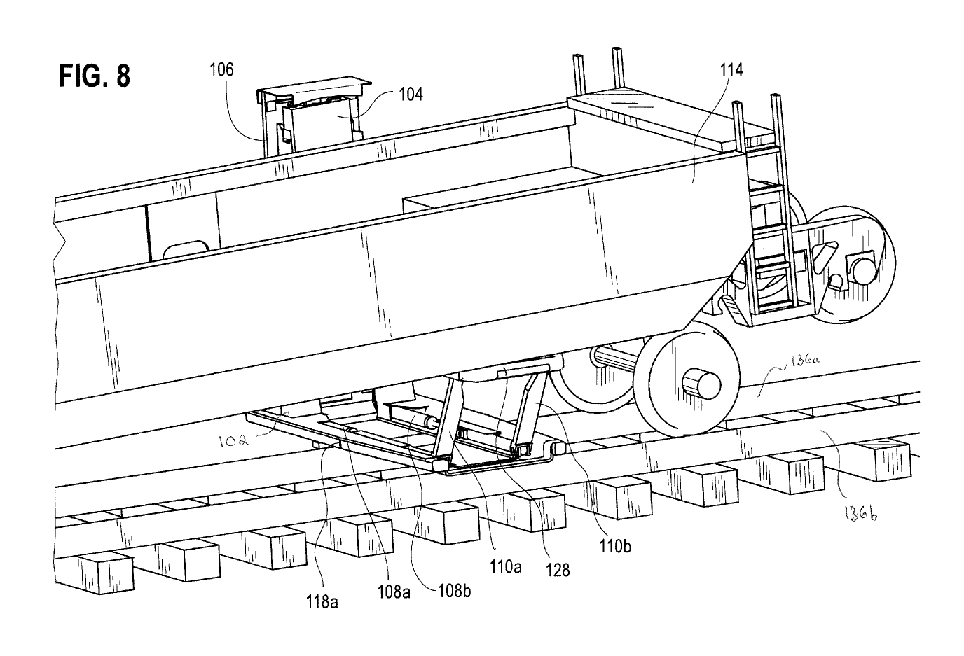

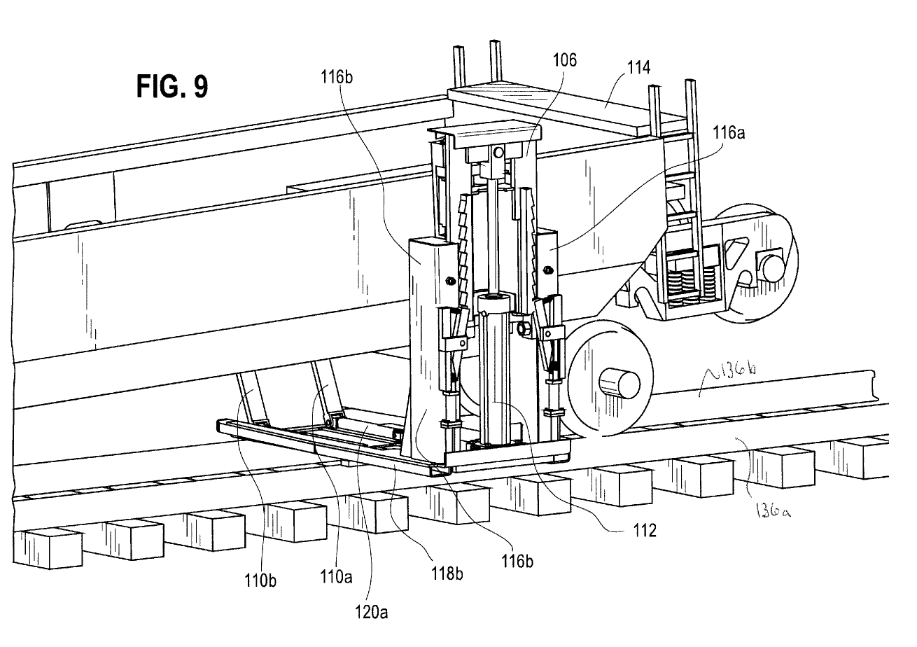

As shown in FIGS. 8 and 9, when the load plate 104 and the back plate 106 reach the second, extended position, the rail car 114 contacts the load plate 104 and is at least partially lifted. One or more of the rail car 114 wheels may be lifted above the rails. The vertical distance the rail car 114 moves depends on both the clearance of the rail car from the rails and the elevation of the upper, extended position reached by the load plate 104. Maintenance on the wheels or undercarriage of the rail car 114 may be performed while the rail car 114 partially rests on the load plate 104 in the second, extended position. Holding of the load plate 104 in the upper, extended position is detailed further below.

As the load plate 104 comes into contact with the underside of the rail car 114 and the rail car 114 begins to rise, the load plate 104 may tilt in one direction, as shown in FIGS. 8 and 9 in order to maintain contact with the rail car 114. Tilting of the load plate 104 is accomplished when the weight of the rail car 114 causes the load plate 104 to tilt in one particular direction. As the weight of the rail car 114 born by the load plate 104 increases, the load plate 104 rotates on the trunnion 122 extending through the channel 126 along the horizontal axis of the load plate 104. Referring ahead to FIG. 15, the channel 126 is a concave arch on the bottom of the distal end 124 of the load plate 104. The axis of the arched channel 126 is horizontal and perpendicular to the rails 136a, 136b. The trunnion 122 contacts the bottom of the channel 126 with rollers 162a, 162b having axes parallel to the axis of 126. The rollers 162a, 162b are arranged within the trunnion 122 and the load plate 104 rests on said rollers 162a, 162b. In the example embodiment shown, a vertical shaft 164 protrudes down from the channel 126. The shaft 164 may be welded to the bottom surface of the load plate 104 in the channel 126. A single, relatively large diameter roller 166 (see FIG. 12 also) is orientated with a vertical hole corresponding to the vertical shaft 164 such that the roller 166 is arranged on the shaft 164. This roller 166 movably couples the trunnion 122, the protective end cap 128, and the load plate 104 together proximal the distal end 124 of the load plate 104.

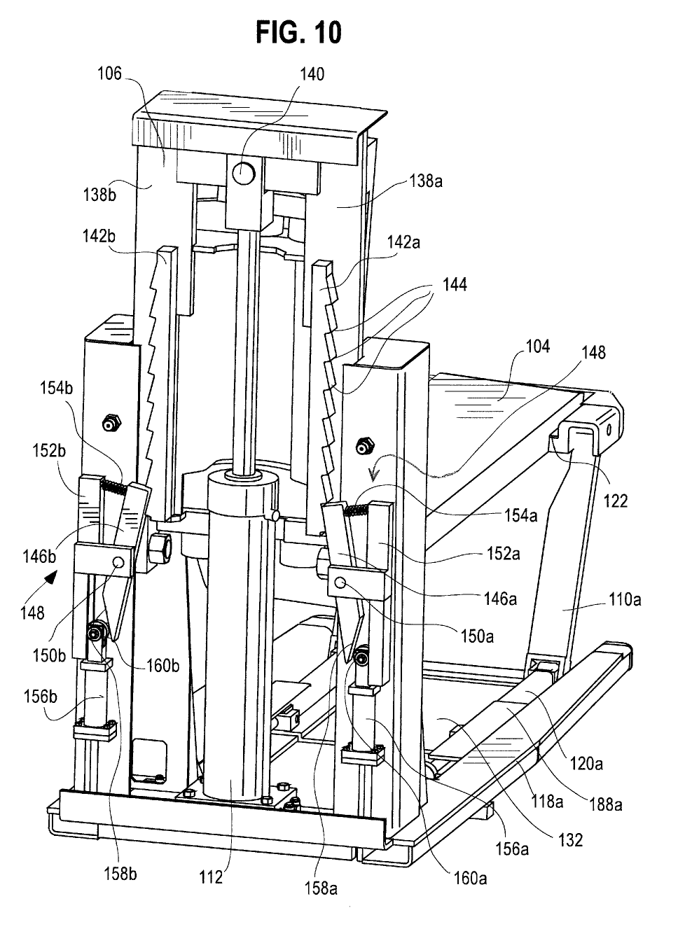

Referring now to FIG. 10, the back of the lifting device 100 is shown in greater detail. Once the rail car 114 has been raised to a desired height, the actuators 108a, 108b, 112 are stopped, and the lifting device 100 supports the rail car 114, thereby allowing work crews to perform maintenance or whatever work is required on the car 114. The backside of the frame, facing away from the railway in the embodiment shown here, includes the first and second side members 116a, 116b along either side of the back plate 106. Likewise, the back plate 106 may be a continuous plate or may be separated into first and second adjacent back plate members 138a, 138b arranged alongside the first and second side members 116a, 116b of the frame 102.

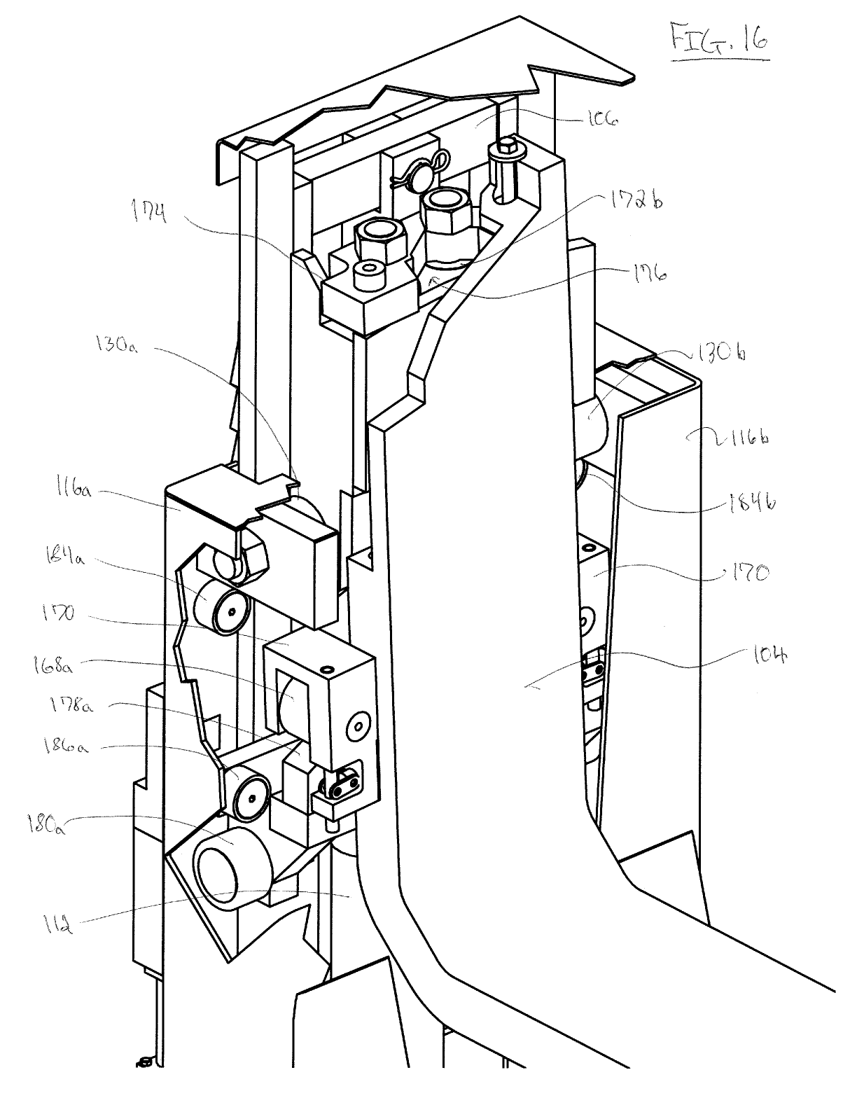

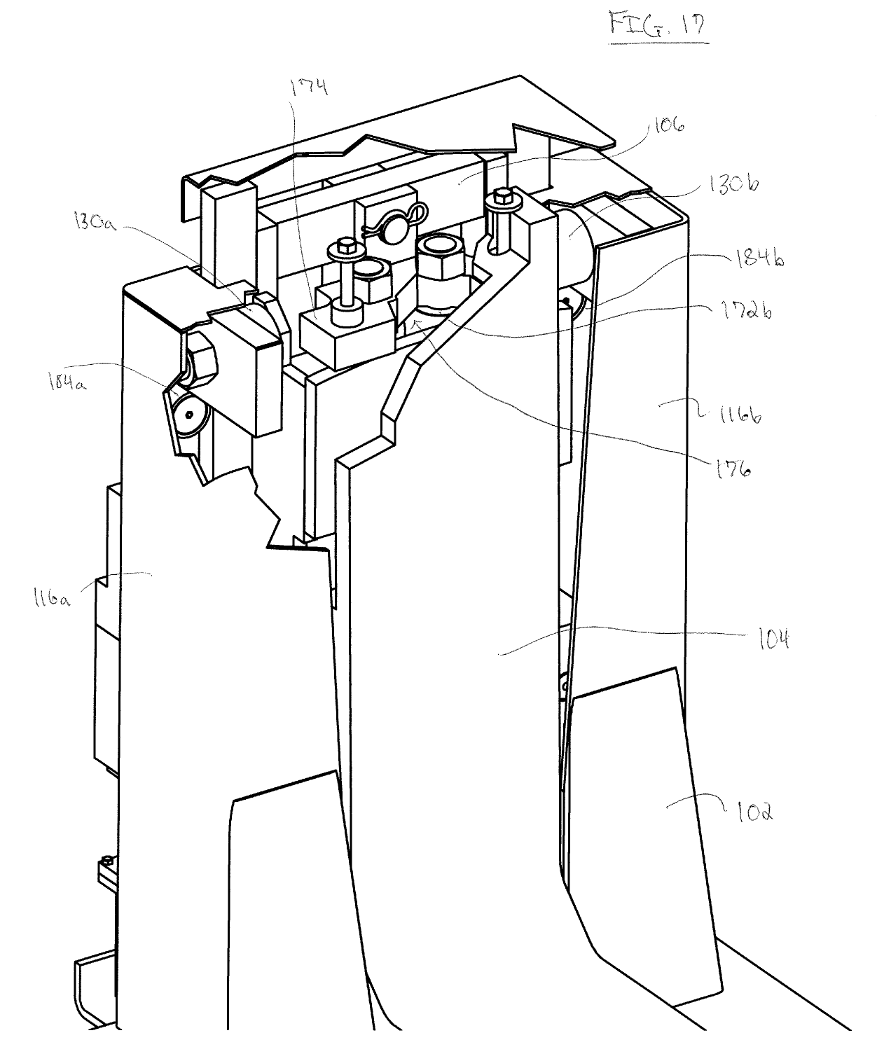

Referring ahead now to FIGS. 12, 16, and 17, each side member 116a, 116b contains a roller 130a, 130b or another suitable contact point along which the back plate 106 or respective back plate member 138a, 138b travels during vertical movement. Further, relatively small rollers 184a, 184b may be mounted to the interior of the side members 116a, 116b to roll along the outer vertical side edge of back plate members 138a, 138b. In addition to rollers mounted on the frame 102, each side member 116a, 116b may contain a guide surface and rollers may be located on either side of the back plate 106 or on each respective back plate member 138a, 138b to provide another suitable contact point along which the back plate 106 travels. Specifically, relatively small rollers 186a, 186b located on back plate members 138a, 138b contact the inner surfaces of side members 116a, 116b to guide the movement of the back plate 106. Embodiments further include some combination of guide surfaces and rollers to provide a track within each side member 116a, 116b to guide the respective back plate members 138a, 138b during vertical movement of the back plate 106.

Further in this embodiment, the load plate 104 tilts independent of the back plate 106, which remains vertical. Load plate 104 rotates on an axis where the load plate 104 is coupled to the back plate 106, the axis being parallel to the axis where the channel 126 rotates on the trunnion 122 (see FIG. 15). Referring again to FIGS. 12, 16, and 17, lower rollers 168a, 168b are held in bracket 170 that, in turn, is attached to load plate 104. Upper rollers 172a, 172b are fixed to roller plate 174 that is fixedly attached to the load plate 104. The vertical load resulting from rail car 114 being raised is transferred from load plate 104 through lower rollers 168a, 168b to the back plate 106 and thereby to the frame 102. Upper rollers 172a, 172b hook onto the back plate in cavity 176 to lever the top of the load plate 104 towards the back plate 106. The lower rollers 168a, 168b are arranged vertically near the bottom of back plate 106 in contact with angles 178a, 178b. The angles 178a, 178b of the back plate 106 support the load of the load plate 104 as transferred thereto through the lower rollers 168a, 168b.

Further, the back plate 106 has coupled thereto horizontal rollers 180a, 180b and vertical rollers 182a, 182b. The vertical rollers 182a, 182b contact the bottom back surface of the load plate 104 and form an operative pairing with the horizontal rollers 180a, 180b. The horizontal rollers 180a, 180b transfer a load from the back plate 106 to the side members 116a, 116b of the frame 102 while the bottom rear of the load plate 104 transfers a load through the vertical rollers 182a, 182b to the back plate 106. Thus, the lower rollers 168a, 168b, upper rollers 172a, 172b, horizontal rollers 180a, 180b, and vertical rollers 182a, 182b movably dispose the load plate 104 on the back plate 106. The combination of rollers provides for shifting of weight as the load plate 104 tilts under the load of the raised rail car 114 while the back plate 106 remains anchored. The back plate 106 does not tilt in this example embodiment, but remains substantially vertical while guided and held in place by the guide surfaces and rollers of the side members 116a, 116b.

The pressure born by the frame side members 116a, 116b due to the load on the load plate 104 is greatest when the load plate 104 is nearest the first, retracted position (see FIGS. 1 and 2). This occurs because the angle of the arm members 110a, 110b is lowest in the first, retracted position so the resultant vertical force provided by said arm members 110a, 110b is lower than once the arm members 110a, 110b move from horizontal to nearer vertical.

Once the load plate 104 contacts the bottom of the rail car 114 the suspension springs of the rail car 114 must be off loaded before the load plate 104 bears the full load of the rail car 114. Thus the load is not maximized until after the angle between the arm members 110a, 110b and the horizontal leg members 118a, 118b has increased resulting in the arm members 110a, 110b supporting more of the load and thereby reducing the moment at the frame side members 116a, 116b. Reduction of moment experienced at the side members 116a, 116b is important at this stage because the horizontal rollers 180a, 180b and the rollers 130a, 130b that transfer the forces from the back plate 106 to the frame side members 116a, 116b are moving nearer one another as the back plate 106 rises vertically. The convergence of the rollers focuses the point on the frame side members 116a, 116b supporting the load and elevates the load supporting point along the frame 102.

The rollers 130a, 130b nearer the top of the frame 102 are attached to the frame side members 116a, 116b while the horizontal rollers 180a, 180b are attached to the bottom of the back plate 106, as detailed above. When the arm members 110a, 110b reach the second, extended position of about 70 degrees, more than half of the weight of the rail car 114 is supported by the arm members 110a, 110b. Because such a significant portion of the weight of the rail car 114 is carried by the arms 110a, 110b in the second, extended position, the optimal angle for transferring said weight to the rail 136b is utilized in this position.

In an alternative embodiment, the back plate 106 may tilt at the same time as when the load plate 104 tilts, as discussed in further detail above. The rollers 130a, 130b located on the frame side members 116a, 116b may be spring loaded so that the rollers 130a, 130b maintain contact with and travel along their respective back plate members 138a, 138b until the first vertical actuator 112 reaches its desired length of travel. In an alternative embodiment, the first vertical actuator 112 may be pinned to the bottom of the frame 102 so as to allow the actuator 112 to tilt along with the back plate 106.

Referring still to FIG. 10, the back plate 106 is shown in greater detail. In this embodiment, the first vertical actuator 112 is operatively coupled to the back plate 106 by a hinge pin 140 located near the upper portion of the back plate 106. The hinge pin 140 allows the back plate 106 to tilt, thereby allowing the load plate 104 to tilt as described above. In various embodiments, the back plate 106 and the load plate 104 may be coupled to one another by connection points that allow the load plate 104 to tilt independently from the back plate 106, or the back plate 106 and the load plate 104 may be fixedly attached to one another such that both plates tilt in unison or simultaneously.

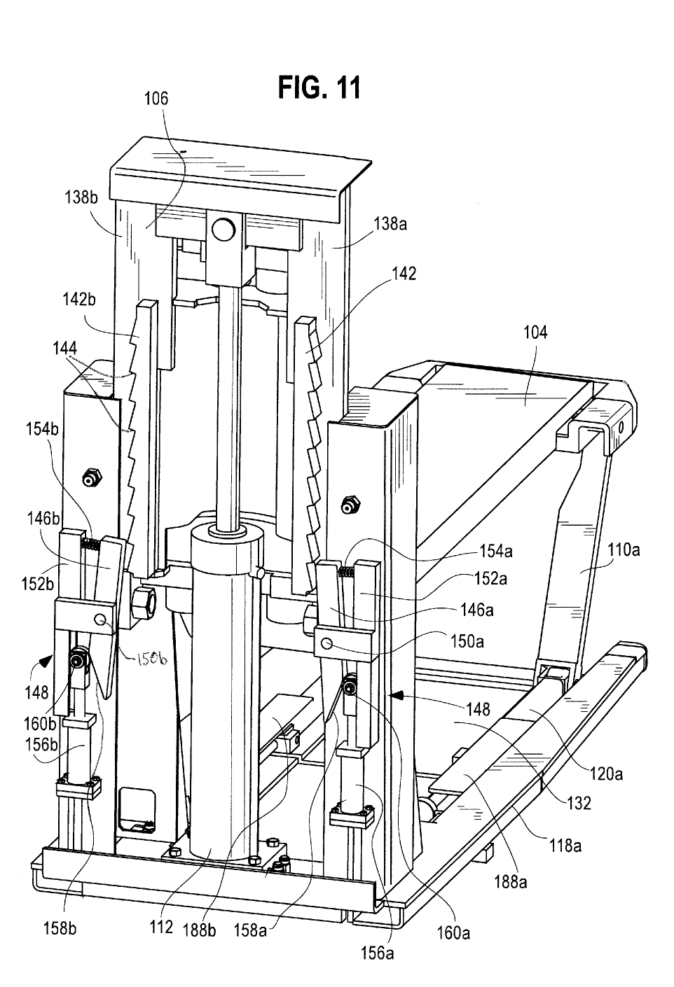

The back plate 106 has first and second ladders 142a, 142b of support ledges 144 arranged along each side thereof. Each support ledge 144 of the ladders 142a, 142b is shaped to accept a support pin 146a, 146b disposed on the respective frame side member 116a, 116b. In the embodiment depicted in FIGS. 10 and 11, the ladders 142a, 142b are disposed on the first and second adjacent back plate members 138a, 138b. The ladders 142a, 142b protrude from the back plate members 138a, 138b such that the support ledges 144 extend out from the back plate 106 and past the first and second side members 116a, 116b of the frame 102.

Furthermore, the first and second frame side members 116a, 116b have disposed thereon a pin mechanism 148 for engaging and disengaging the support pins 146a, 146b with the support ledges 144 of the respective first and second ladders 142a, 142b. Each pin mechanism includes the support pin 146a, 146b, support pin hinge 150a, 150b, support pin mount 152a, 152b, and support pin spring 154a, 154b. Second and third vertical actuators 156a, 156b are disposed on the first and second frame side members 116a, 116b and are operatively coupled to the respective pin mechanism 148 on each side.

The pin mechanisms 148 are substantially identical therefore, only a first side will be described in detail. The support pin mount 152a is fixedly attached to the frame side member 116a. Disposed on the mount 152a are the support pin hinge 150a and the support pin spring 154a. The support hinge 150a, travels through the support pin 146a, and attaches to the frame side member 116a thus joining the support pin 146a thereto. The support pin spring 154a is arranged between a top portion of the mount 152a and a top portion of the support pin 146a. The spring 154a pushes the support pin 146a away from the mount 152a thereby causing the support pin 146a to pivot on the hinge 150a.

The consistent pressure of the spring 154a pushes the support pin 146a to contact the ladder 142a such that as the ladder 142a moves upwards the support pin 146a cams therealong. As the back plate 106 and ladder 142a rise, the support pin 146a engages with successive support ledges 144 along the vertical length of the ladder 142a. In this way, the back plate 106 becomes locked above particular heights corresponding to support ledges 144. Such a mechanism for providing support to the back plate 106, and therethrough supporting the load plate 104, is arranged on both the first and second side frame members 116a, 116b so as to support the back plate 106 from both sides.

The above describe support mechanism ensures that the load plate 104 is supported even when the first vertical actuator 112 is not providing a supportive or motive upward force on the back plate 106. The support pins 146a, 146b may provide support to the back plate 106 and load plate 104 when the vertical actuator 112 is not providing an upward force for the purpose of saving energy, preserving battery life, or as a safety mechanism that prevents sudden downward vertical movement of the load plate 106 and the rail car 114 resting thereon. The support pins 146a, 146b therefore protect personnel and/or equipment beneath the lifted load plate 104 and rail car 114. The spring tension keeps the support pins 146a, 146b engaged even when the back plate 106 tilts with the load plate 104 by maintaining consistent pressure on the pins 146a, 146b but also allowing the pins 146a, 146b to compress the springs 154a, 154b, if necessary, while remaining engaged with the ladders 142a, 142b.

In alternative embodiments, a support mechanism similar to the above-described mechanism of support pins ratcheting the back plate 106 may be used to hold the positions of the arm members 110a, 110b when supporting the weight of the rail car 114. Such an additional support mechanism may be arranged along the first and second leg members 118a, 118b, or under the distal end 124 of the load plate 104. Further, alternative embodiments may include a single support mechanism as described above connecting the back plate 106 and frame 102, as opposed to support mechanisms on each side of the back plate 106 and the respective side frame members 116a, 116b. In still further alternative embodiments, more than two support mechanisms similar to that described above may be included for supporting the back plate 106 with the frame 102.

As discussed above, the support pins 146a, 146b engage the ledges 144 of their respective ladders 142a, 142b during the vertical rise of the back plate 106. To lower the rail car 114, the process described above is reversed and the first vertical actuator 112 and the first and second horizontal actuators 108a, 108b are retracted. Retraction of the first vertical actuator 112 allows the back plate 106 to lower vertically. Likewise retraction of the first and second horizontal actuators 108a, 108b pulls the ends of the moveable arm members 110a, 110b toward the frame side members 116a, 116b, thus causing the distal end 124 of the load plate 104 to move in a generally downward direction while, at the same time, the back plate 106 is lowered between the side frame members 116a, 116b.

Alternatively, the actuators 112, 108a, 108b may not actively retract the back plate 106 and arm members 110a, 110b, but instead simply allow the back plate 106 and load plate 104 to lower under the power of gravity, guided by the rollers 130a, 130b, within the side frame members 116a, 116b, and the arm members 110a, 110b. The actuators 112, 108a, 108b may further provide only limited resistance to allow for a controlled descent of the back plate 106 and load plate 104.

For the back plate 106 to lower, either under power of gravity or in response to retraction of the first vertical actuator 112, the support pins disengage from the support ledges 144. The second and third vertical actuators 156a, 156b disposed below the support pin mechanisms 148 provide disengagement of the support pins 146a, 146b. The second and third vertical actuators 156a, 156b contact the support pins 146a, 146b at a lower end, distal to the end of the support pin that engages the ledges 144. The lower end of each support pin 146a, 146b has an angled surface 158a, 158b thereon. Further, each of the second and third vertical actuators 156a, 156b has a roller 160a, 160b disposed on the end thereof for operatively contacting the angled surfaces 158a, 158b of the support pins 146a, 146b. The second and third vertical actuators 156a, 156b may be hydraulic cylinders, pneumatic cylinders, electric linear actuators, or any other suitable type of actuator.

The disengagement of the support pins 146a, 146b will be described with respect to a first side only because the lowering of the back plate 106 operates in a similar fashion on both sides of the frame 102. Referring now to FIG. 11, the vertical actuator 156a extends until the roller 160a applies pressure to the angled surface 158a on the bottom end of the support pin 146a. The force of the vertical actuator 156a, as applied through the roller 160a, causes the support pin 146a to hinge on the support pin hinge 150a. The vertical actuator 156a provides enough pressure that the support pin 146a levers against the support pin spring 146a thereby compressing the spring 146a.

Upon compression of the support pin spring 146a by the upper end of the support pin 146a, the upper end of the support pin 146a disengages the ledge 144 with which it was engaged. The vertical actuator 156a applies continued force such that the spring 154a remains compressed allowing the upper end of the support pin 146a to clear the ledges 144 of its respective ladder 142a during descent of the back plate 106 to the first, retracted position. When the actuators 112, 108a, 108b are fully retracted and the lifting device 100 is in the first, retracted position, the rail car 114 is repositioned on the rails.

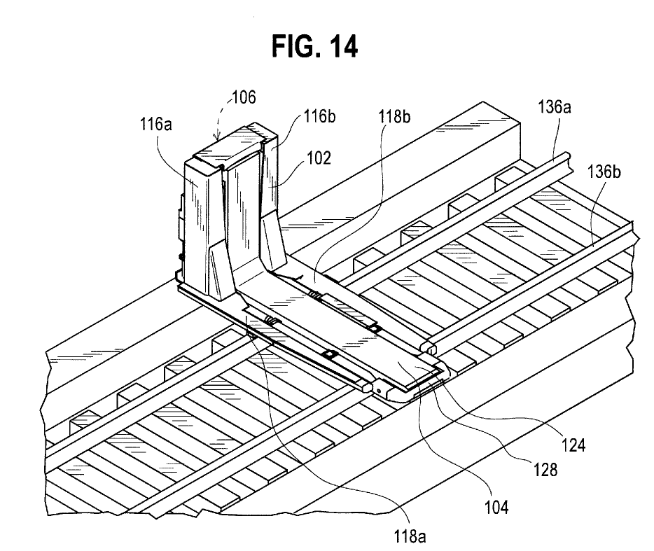

Referring now to FIGS. 13 and 14, during operation, the lifting device 100 is placed next to the rail car 114 with the load plate 104 substantially perpendicular to the rails. The lifting device 100 may be supported by the rails, the ground alongside the railway, or another structure along the railway. The first and second horizontal leg members 118a, 118b of the frame may rest directly on the rails as shown in FIG. 13. The frame 102 may also support other equipment such as a wheel-changing device, controls, or other maintenance or safety apparatuses. In an embodiment, the lifting device 100 may be used to raise a rail car 114 to effect a change of the wheel and axle assembly.

The lifting device may be controlled manually with a simple up and down lever. The actuators used therein may be all hydraulic actuators with quick connections to an external hydraulic supply. Alternatively, a hydraulic power supply may be mounted directly on the frame 102. In example embodiments, a gas or diesel engine or electric motor may drive a pump, tank, and/or controls mounted to the frame 102. Such a system may use manual hydraulic lever valves or solenoid valves with push button controls. Limit switches may be used to sense the first, retracted position and the second, extended position of the load plate 104. Limit switches may also be used to verify conditions prior to operation such as engagement and/or disengagement of the support pins 146a, 146b or any other similar support mechanism. The controls used for the lifting device 100 may be combined with various other sensors, such as sensors that verify that a specific area is clear of obstacles prior to lowering the load plate 104.

In an alternative embodiment, electronics could be used to control the hydraulic pressure and flow during raising and lowering of the load plate 104. Strain gauges may be appropriately installed to measure and report the load being lifted as well as the state of stress for critical components. In an example embodiment, the hydraulic actuator cylinders may be sized such that a single pressure level applied to the lifting device 100 results in all the cylinders producing the appropriate forces.

The embodiment(s) detailed above may be combined, in full or in part, with any alternative embodiment(s) described.

As many changes could be made in the above constructions without departing from the scope of the disclosure, it is intended that all matter contained in the above description or shown in the accompanying drawings, can be interpreted as illustrative and not in a limiting sense.

### INDUSTRIAL APPLICABILITY

Currently wheel changing and other maintenance to components of a rail car is performed with the aid of a number of pieces of heavy machinery such as cranes and jacks carried by wheel trucks or sidewinder vehicles. This equipment is expensive to produce, operate, and maintain. The equipment itself, as well as skilled personnel trained to use such equipment, represents a considerable investment.

A device or method that lifts a rail car and facilitates maintenance thereof by a limited number of people and pieces of equipment may be an advancement within the industry. The device described hereinabove is designed to lift fully loaded, double-stacked rail cars. A device capable of lifting fully loaded rail cars may present further advantages such as timesavings and increases in efficiency.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

We claim:

1. A lifting device for lifting a rail car comprising:
a frame;
a load plate movably disposed on the frame;
a back plate movably disposed on the frame and coupled to the load plate;
a first actuator disposed on the frame and operatively coupled to the back plate; and
at least one second actuator operatively coupled to the load plate;
wherein the first actuator and the at least one second actuator produce forces in first and second directions; and
wherein the first actuator and the at least one second actuator move the load plate in a substantially vertical direction.

2. The lifting device of claim 1, wherein the frame further comprises:
first and second side members disposed adjacent to and spaced apart from one another; wherein the first and second side members are disposed on first and second sides of the back plate.

3. The lifting device of claim 2, wherein the frame further comprises:
first and second leg members disposed adjacent to and spaced apart from one another;
wherein the first and second leg members are disposed on the first and second sides of the load plate; and
wherein the back plate is movably attached to each of the first and second side members, and the load plate is operatively coupled to the first and second leg members through first and second arm members.

4. The lifting device of claim 1, wherein the load plate tilts in response to a weight of the rail car being raised by the load plate such that a surface of the load plate maintains contact with a bottom surface of the rail car.

5. The lifting device of claim 4, wherein the load plate tilts independent of the back plate while the back plate partially transmits the force produced by the first actuator to the load plate.

6. The lifting device of claim 5, wherein the at least one arm member is movably attached to a distal end of the load plate by at least one trunnion, the at least one trunnion allowing the at least one arm member to transmit the force produced by the at least one second actuator to the load plate while tilting such that the load plate maintains contact with the bottom surface of the rail car.

7. The lifting device of claim 1, further comprising:
at least one side member;
at least one leg member; and
at least one arm member;
wherein the load plate is operatively coupled to the at least one leg member through the at least one arm member.

8. The lifting device of claim 7, wherein the back plate at least partially transmits the force produced by the first actuator to the load plate; and
wherein the at least one arm member at least partially transmits the force produced by the at least one second actuator to the load plate.

9. The lifting device of claim 8, the at least one arm member further comprising first and second arm members movably attached to the load plate; and
the at least one second actuator further comprising first and second horizontal actuators disposed alongside the at least one leg member; and
wherein the first and second arm members are operatively coupled to the respective first and second horizontal actuators.

10. The lifting device of claim 9, the at least one side member further comprising first and second side members disposed about the first actuator;
wherein the first actuator is a vertical actuator and the first actuator moves the back plate vertically along the first and second side members;
wherein the back plate at least partially transmits a load supported by the load plate to the frame; and
wherein the first and second arm members at least partially transmit the load supported by the load plate to the at least leg member.

11. The lifting device of claim 9, the at least one leg member further comprising first and second leg members;
wherein the first and second arm members transmit the force produced by the first and second horizontal actuators to the load plate by hinging between the first and second leg members and a distal end of the load plate.

12. The lifting device of claim 11, wherein an angle formed between the first and second arm members and the respective first and second leg members when the load plate reaches an extended position transfers the load from the first and second arm members to a rail of the rail way.

13. The lifting device of claim 7, further comprising:
a least one support pin mechanism disposed on the at least one side member; and
wherein the at least one support pin mechanism at least partially supports the load plate after the load plate has been moved in the substantially vertical direction.

14. The lifting device of claim 13, further comprising:
at least one ladder of support ledges disposed on the back plate; and
at least one support pin;
wherein the at least one support pin mechanism causes the at least one support pin to engage the respective at least one ladder of support ledges, and the back plate is held in an elevated position thereby; and
wherein the load plate is supported when the back plate is held in the elevated position.

15. The lifting device of claim 14, wherein the at least one support pin mechanism further comprises at least one spring;
wherein the at least one spring provides consistent pressure such that the at least one support pin is continuously engaging the support ledges of the at least one ladder; and
wherein the at least one support pin mechanism is capable of holding the back plate in more than one elevated position.

16. The lifting device of claim 15, wherein the at least one support pin mechanism further comprises at least one third actuator, the at least one third actuator operatively coupled to the at least one support pin such that operation of the at least one third actuator disengages the at least one support pin from the respective support ledge.

17. A method of lifting a rail car comprising:
arranging a lifting device across a rail way such that a rail car is above the lifting device;
wherein the lifting device includes a frame; and
wherein a load plate is movably disposed on the frame and a back plate is movably disposed on the frame and coupled to the load plate;
raising the rail car by moving the load plate vertically, further comprising:
activating a first actuator disposed on the frame and operatively coupled to the back plate, the first actuator producing a force in a first direction; and
activating at least one second actuator operatively coupled to the load plate, the at least one second actuator producing a force in a second direction transverse to the first direction;
wherein the first actuator and the at least one second actuator together operate to move the load plate vertically.

18. The method of claim 17, wherein the activating at least one second actuator further comprises activating first and second horizontal actuators disposed alongside the load plate,
wherein first and second arm members are movably attached to the load plate and operatively coupled to the respective first and second horizontal actuators such that the first and second horizontal actuators operate on the first and second arm members to at least partially move the load plate vertically.

19. The method of claim 18, wherein the first actuator is a vertical actuator and activating the first actuator at least partially moves the back plate vertically;
wherein activating the first actuator at least partially transmits the force produced by the first actuator through the back plate to the load plate;
wherein the first and second arm members at least partially transmit the force produced by the first and second horizontal actuators to the load plate through a hinging motion.

20. The method of claim 19, further comprising tilting the load plate under a weight of the rail car independent from the back plate such that a surface of the load plate remains in contact with a bottom surface of the rail car while the rail car is lifted vertically and a load supported by the load plate is at least partially transferred to the back plate.
